(19) United States
(12) Patent Application Publication
(10) Pub. No.: US 2008/0032085 A1
(43) Pub. Date: Feb. 7, 2008

(54) Window screen tape

(76) Inventor: Ken Hendriksen, Carrollton, TX (US)

Correspondence Address: WILSON DANIEL SWAYZE, JR., 3804 CLEARWATER CT., PLANO, TX, 75025, US

(21) Appl. No.: 11/499,571

(22) Filed: Aug. 4, 2006

(51) Int. Cl. B32B 3/26

(52) U.S. Cl. 428/63

(57) ABSTRACT

A patching system for repairing a screen having a defect in it includes a patch adapted to be positioned on a side of the screen. The patch includes holes having a size approximating a hole of the screen. The patching system additionally includes an adhesive to form a detachably connection with the screen and positioned on the patch.

### FIELD OF THE INVENTION

This invention relates to the field of screen repair, and more specifically to a patching system and method for repairing a screen having a defect in it.

### DESCRIPTION OF THE PRIOR ART

It is not uncommon for screens employed in doors and windows to become torn, cut, or otherwise damaged. When this occurs, insects can pass through the screen, creating very undesirable living conditions.

For decades the most common technique for repairing screens has been to secure a single patch, itself formed of a screen material, to the screen in overlying relationship with the defect. This type of patch generally is cumbersome to work with, is extremely unsightly, and sometimes includes wire-like fasteners that can cut or otherwise injure a person attempting to repair the screen. Moreover, these fasteners sometimes project outwardly from the screen, and can catch onto articles of clothing and rip them when individuals accidently brush against the screen.

The following patents, which were considered in the preparation of this application, disclose various different types of wire mesh patches for use in repairing damaged screens: U.S. Pat. No. 1,324,845 (Osgood); U.S. Pat. No. 1,792,594 (Litwin); U.S. Pat. No. 2,272,196 (Gittens); U.S. Pat. No. 2,283,803 (Gittens); U.S. Pat. No. 2,487,830 (Robbins II) U.S. Pat. No. 1,927,826 (Friday); U.S. Pat. No. 2,241,257 (Gronberg); U.S. Pat. No. 1,749,755 (Downer) and U.S. Pat. No. 1,998,033 (Tucker).

U.S. Pat. No. 276,100, issued to Vedder, discloses the use of single decorative blocks, such as those indicated at B in FIGS. 3, 5 and 7-9, to close openings in a lattice structure. Vedder is in no way concerned with the problems associated with repairing defects in torn or damaged screens, and does not remotely suggest a unique patching system and method of the type forming the subject matter of the present invention.

U.S. Pat. No. 4,222,162 discloses a patching system for repairing a screen with a defect and includes two separate patches adapted to be positioned on opposite sides of the screen, each patch including a cover section adapted to overlie the defect and mechanical fastening means adapted to face inwardly toward the screen, the mechanical fastening means of one patch being mechanical connectable to the fastening means of the other patch through the screen.

### SUMMARY

It is an object of this invention to provide a simple and reliable patching system for repairing defects in screens.

It is a further object of this invention to provide a patching system for repairing defects in screens.

It is a further object of this invention to provide a simple and reliable method for repairing defects in screens.

Other objects and advantages of this invention will become apparent by referring to the description of the best mode for carrying out this invention, taken in conjunction with the drawings.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the patch of the present invention and a damaged screen.

FIG. 2 illustrates a roll of the patch of the present invention.

FIG. 3 illustrates a cross-sectional view of another embodiment of the patch of the present invention.

FIG. 4 illustrates a perspective view of the patch of the present invention with a damaged screen.

FIG. 5 illustrates a cross-sectional view of the patch of the present invention.

FIG. 6 illustrates a side view of the other embodiment of the present invention.

### DESCRIPTION

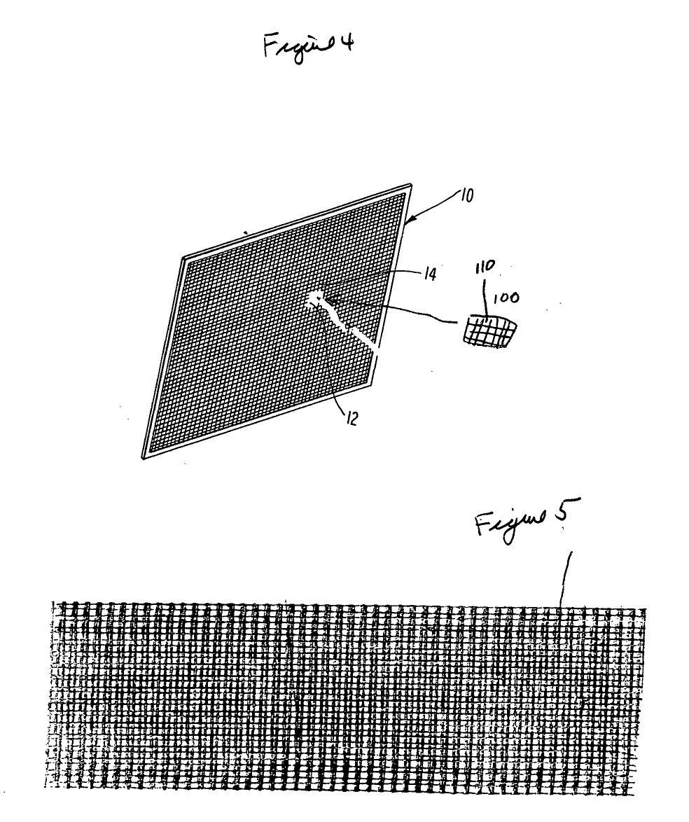

Referring to FIG. 4, a screen 10 is shown with a defect 12 in the form of an opening surrounded by undamaged screen areas 14. In accordance with this invention, a patching system includes a single patch 100 adapted to be secured over the defect 12 on either side of the screen 10 and having holes 110 approximately the same size as the screen 10. The patch 100 is unwound from a roll 200 which may be produced in varying widths and lengths to accommodate various sized defects 12. FIG. 4 illustrates the patch 100 being applied to the defect 12.

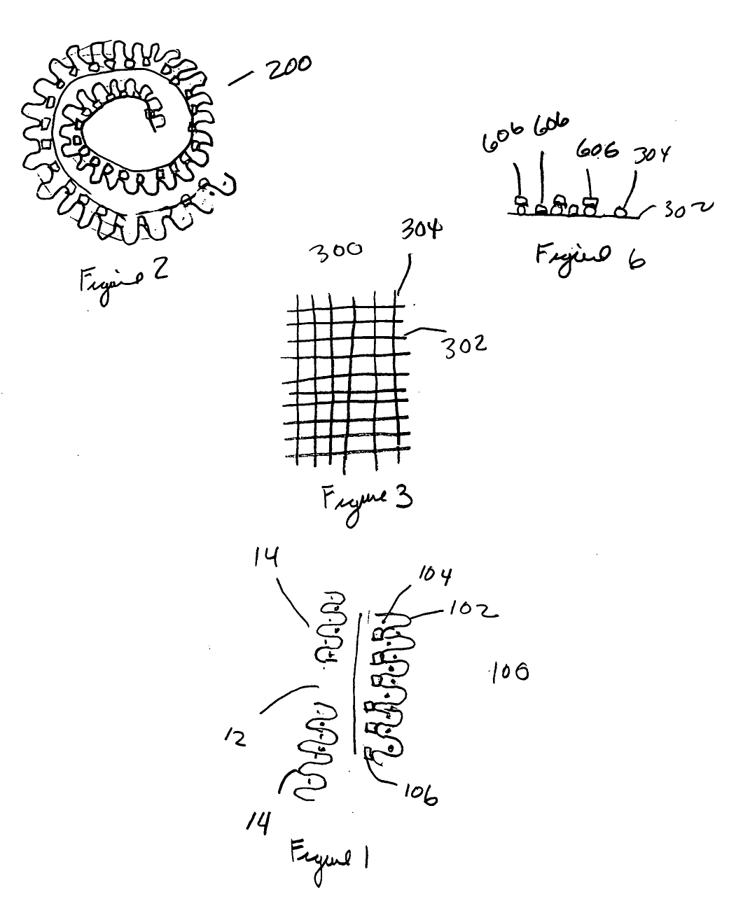

FIG. 1 illustrates a side view of the patch 100 of the present invention. FIG. 1 shows that the patch 100 includes an inner locking screen including first interlocking element 102 and second interlocking element 104. Each of the first interlocking element 102 and the second interlocking element 104 includes adhesive 106 on a portion of the first interlocking element 102 and a second interlocking element 104. Additionally, FIG. 1 shows a release sheet 108 to prevent contamination of the adhesive 106 or adhesive layer on a portion of the first interlocking element 102 and the second interlocking element 104. The adhesive may be weather and moisture resistant. The release sheet 108 is removed and the adhesive is pressed against the undamaged screen 14 which forms a detachably connection with the patch 100. The first interlocking element 102 and the second interlocking element 104 may be formed from metal, plastic, fiberglass or other such similar material.

FIG. 2 illustrates a roll of tape 200 of patch 100. The roll of tape 200 could be formed of varying widths for various sized defects 12.

FIG. 3 illustrates a patch 300 which may be a flexible mesh including first element 302 which is shown in the approximate horizontal direction and the second element 304 which is shown in the approximate vertical direction. The first element 302 and the second element 304 may be formed from metal, plastic, fiberglass or any other suitable material and may be round, rectangular or any other suitable cross-sectional shape.

The mesh includes holes 306 formed by the intersection of the first element 302 and the second element 304. The holes 306 are approximately the same size as the holes found in screen 14 so that an aesthetic and pleasing repair is made by the patch 300.

FIG. 6 illustrates a side view of the patch 300. The second element 304 is formed substantially perpendicular to the first element 302. A portion of the first element 302 and a portion of the second element 304 is covered with adhesive 306 to make a detachably connection with the undamaged screen 14.

FIG. 5 illustrates a section of the roll of the patch 300.

The patch of the present invention may be referred to as a window screen tape which provides a the immediate solution to screen problems that keeps insects out and still allows ventilation in. The patch of the present invention is simple to use, manufacture and cost-effective to manufacture. The patch of the present invention can be used in all window screens, screen houses, tents as well as other uses. The patch at the present invention provides a window screen repair product that immediately repairs damaged window screens on a permanent or temporary basis.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A patching system for repairing a screen having a defect in it, said system comprising:
a patch adapted to be positioned on a side of said screen, said patch
including holes having a size approximating a hole of said screen;
an adhesive to form a detachably connection with said screen and positioned on said patch.

2. A patching system for repairing a screen having a defect in it as in claim 1, wherein said patch includes a first interlocking element and a second interlocking element.

3. A patching system for repairing a screen having a defect in it as in claim 2, wherein said first interlocking element and said second interlocking element intersect to form said hole.

4. A patching system for repairing a screen having a defect in it as in claim 1, wherein said patch includes a mesh.

5. A patching system for repairing a screen having a defect in it as in claim 4, wherein said mesh includes a first element and a second element.

6. A patching system for repairing a screen having a defect in it as in claim 5, wherein said first element and said second element intersect to form said hole.

7. A patching system for repairing a screen having a defect in it as in claim 5, wherein said adhesive is formed on a portion of said first element and said second element.

8. A patching system for repairing a screen having a defect in it as in claim 2, wherein said adhesive is formed on a portion of said first interlocking element and a portion of said second interlocking element.

9. A patching system for repairing a screen having a defect in it as in claim 1, wherein said patch is formed in a roll of tape.
